(19) United States
(12) Patent Application Publication
(10) Pub. No.: US 2012/0272311 A1
(43) Pub. Date: Oct. 25, 2012

(54) METHOD FOR AUTHENTICATING A USER ON A COMPUTING UNIT

(76) Inventors: Christoph Althammer, Regensburg (DE); Martin Kühnel, Sinzing (DE)

(21) Appl. No.: 13/508,134

(22) PCT Filed: Oct. 29, 2010
(86) PCT No.: PCT/DE2010/001265

§ 371 Date: Jul. 6, 2012

(30) Foreign Application Priority Data
Nov. 6, 2009 (DE) 10 2009 052 174.7

(51) Int. Cl. G06F 21/00

(52) U.S. Cl. 726/16

(57) ABSTRACT

The invention relates to a method for authenticating a user on at least one computing unit, in particular a data processing and/or communication device, comprising a graphical user interface unit having a graphical user interface and at least one input device, wherein the at least one graphical user interface comprises at least one symbol storage area having a plurality of graphical symbols and at least one symbol positioning area having a plurality of defined positions.

The invention relates to a method for authenticating a user on a computing unit according to the preamble of claims 1 and 2.

A computing unit according to the invention is understood to be all devices and systems with which a user can interact by means of a graphical user interfacing unit and an input device. These are in particular desktop and laptop computers, mobile phones, personal digital assistants (PDAs), automated machines such as automated teller machines or cash dispensers or terminals that are connected for example to a central computer (client-server environments).

The provision of protected areas on such computing units is sufficiently known in the art. These areas can be the computing unit itself, for example, or file directories or single files. Further, the protected areas can be specific web pages, services or also protected physical areas, such as rooms or buildings, for example. A known authenticating method in particular is to assign each user who is to receive access to the protected area a user ID and to prompt the user for the password after the user ID is entered. Such a password consists of a string of characters that the respective user must enter on an input device, for example a keyboard, to receive access to the protected area.

The disadvantage of this is that complex, unrelated combinations of characters typically are difficult for the human brain to reproduce, so that certain keyboard patterns, words from dictionary entries or personally related words, such as names of family members, are frequently chosen as passwords. Such passwords are referred to as weak passwords, since they are easy to crack. Due to the use of such weak passwords the often complex security mechanisms of present-day computer systems are quickly undermined. To prevent the assignment of weak passwords, so-called complexity rules for passwords are created that force the user to use certain complicated character combinations and therefore do not allow weak passwords. These passwords are therefore extremely difficult for human memory to process, so that frequently the complex password is written down by the user.

Based on this, the object of the invention is to present an authenticating method that extremely user friendly, in particular for reproduction by human memory, while nevertheless offering very high security for the protected areas.

This object is achieved by the characteristics of claims 1 and 2.

The essential aspect of the method according to the invention is that a graphical user interface comprises at least one symbol storage area having a plurality of graphical symbols and at least one symbol positioning area having a plurality of defined positions, wherein the symbols can be used more than once, each symbol of the symbol storage area is associated with at least one symbol ID, each position of the symbol positioning area and the symbol storage area is associated with at least one position ID, moving one symbol respectively from the symbol storage area into the symbol positioning area generates one symbol instance, moving one symbol respectively from the symbol storage area into the symbol positioning area and/or from the symbol positioning area into the symbol storage area and/or within the symbol positioning area generates at least one move vector, which comprises at least the symbol ID of the moved symbol, a source position ID defining the position of the symbol before the move and a target position ID defining the position of the symbol after the move, and the sequence of at least two move vectors and their respective symbol ID, source position ID and target position ID are evaluated for authenticating a user on at least one computing unit.

In one variant of the method according to the invention the graphical user interface comprises at least one symbol storage area having a plurality of graphic symbols and at least one symbol positioning area having a plurality of defined positions, wherein the symbols can be used more than once, each symbol of the symbol storage area is associated with at least one symbol ID, each position of the symbol positioning area and the symbol storage area is associated with at least one position ID, moving one symbol respectively from the symbol storage area into the symbol positioning area generates one symbol instance, graphically moving one symbol respectively from the symbol storage area into the symbol positioning area and/or from the symbol positioning area into the symbol storage area and/or within the symbol positioning area generates at least one move vector, which comprises at least the symbol ID of the moved symbol, a target position ID defining the position of the symbol after the move and an instance ID permanently associated with the respectively used symbol, and the sequence of at least two move vectors and their respective symbol ID, target position ID and instance ID are evaluated for authenticating a user on at least one computing unit.

In a preferred embodiment the instance ID is displayed to the user as being permanently associated with the respective symbol. This allows a higher password strength, since the displayed instance ID makes it possible to differentiate graphically identical symbol instances.

In an especially preferred embodiment a plurality of graphically identical and/or different symbols can be arranged at one position of the symbol positioning area. This makes it possible to generate a sufficiently strong password especially in the case of a symbol positioning area with only a small number of positioning possibilities.

Preferably it is possible to provide, in addition to the relevant symbols for entry of the password, neutral symbols in order to increase the security with respect to third-party observation of the password being entered. These neutral symbols can be moved any number of times to divert an observer from the password-relevant moves. However, the moves of the neutral symbols are not used in the evaluation of the password and therefore represent “dummy moves”.

To create another dimension for generating the password, a move can consist of rotating the symbol instance arranged on the symbol positioning area. The rotation preferably is carried out by discrete angle values, i.e. a symbol instance can be rotated for example by 90°, 180° and 270° from the original orientation, for example by clicking on a defined area of the symbol. This angle information associated with the respective symbol instance is stored in the move vector and evaluated as part of the password information.

Further embodiments, advantages and applications of the invention are also disclosed in the following description of exemplary embodiments and the drawings. All characteristics described and/or pictorially represented, alone or in any combination, are subject matter of the invention, regardless of their being summarized or referenced in the claims. The content of the claims is also an integral part of the description. The invention is illustrated in the drawings, where:

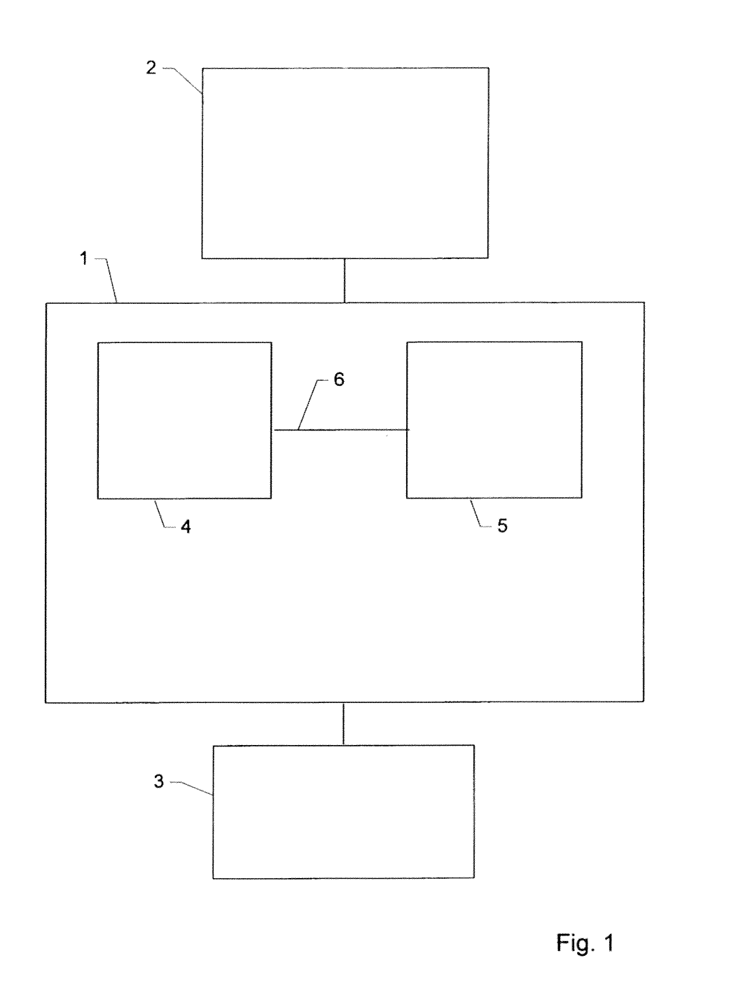

FIG. 1 shows a system for implementing the authenticating method according to the invention;

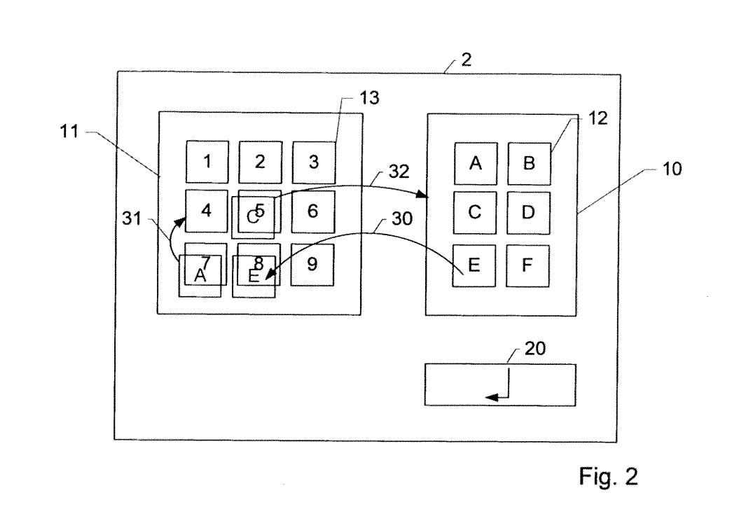

FIG. 2 shows a graphical user interfacing unit with a display for input of the graphical password;

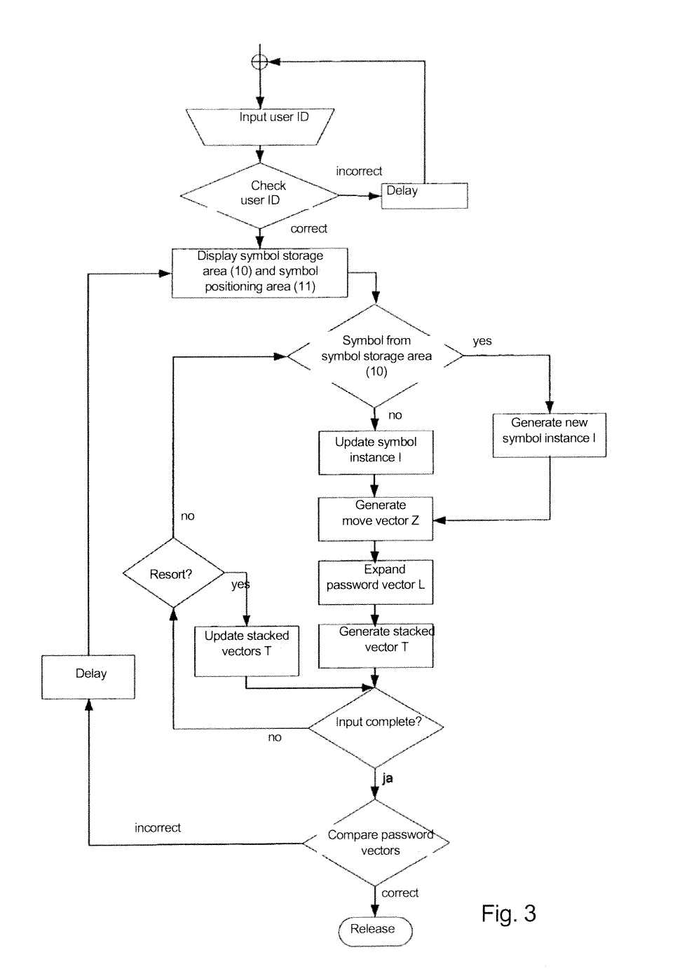

FIG. 3 shows a flow chart for depiction of the steps and processes for input of a graphical password according to a first exemplary embodiment;

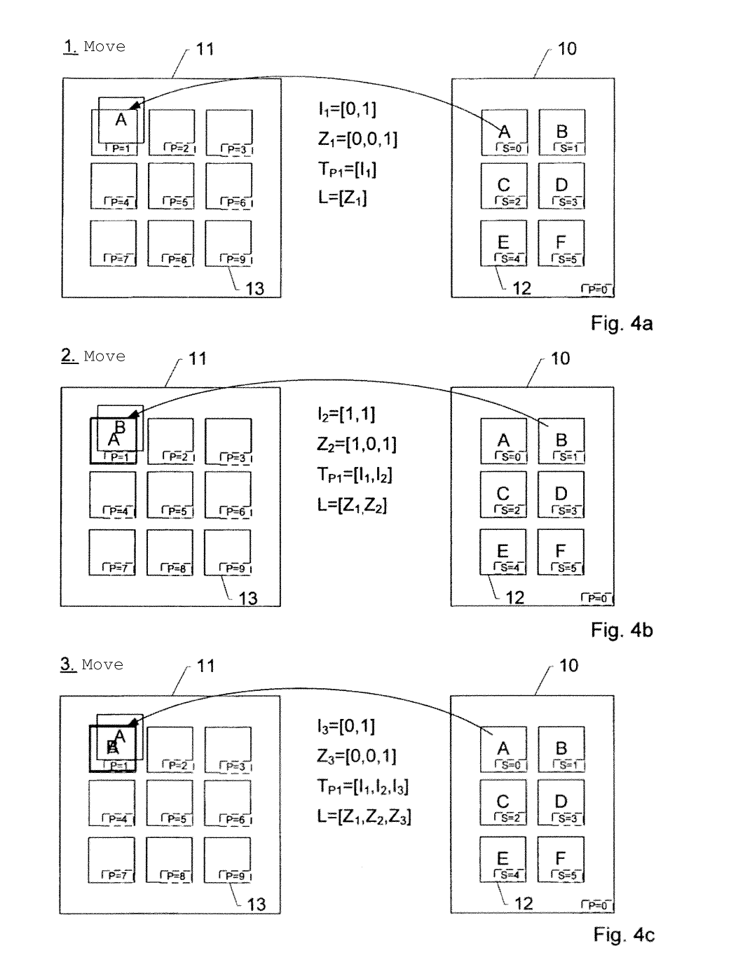

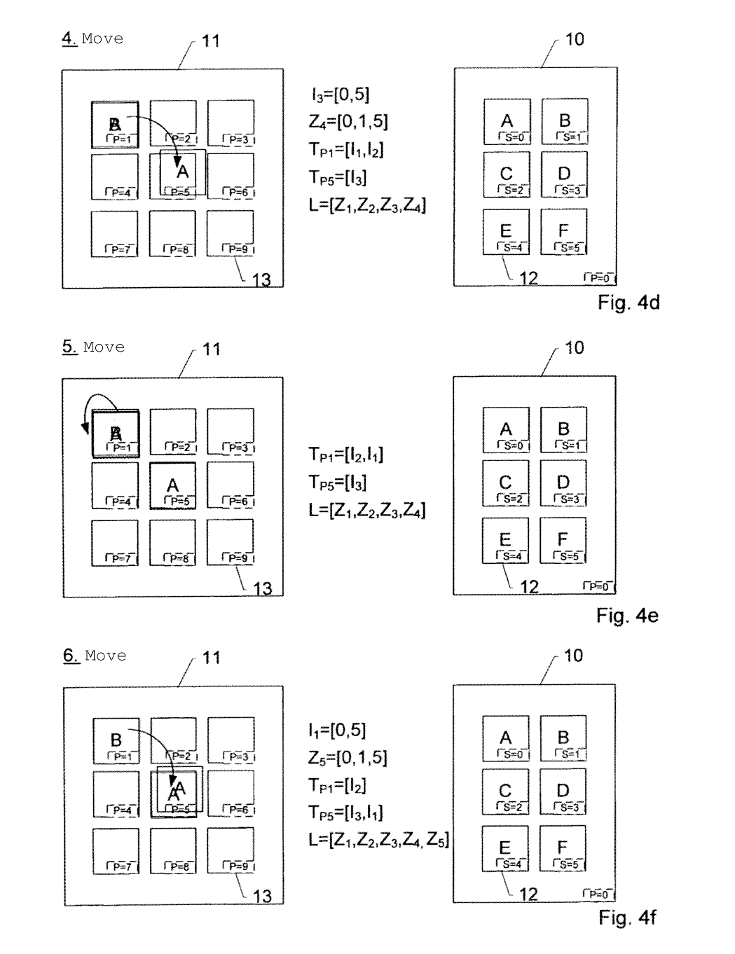

FIGS. 4a-4f show an example of a move with a plurality of moves for input of a graphical password according to a first exemplary embodiment;

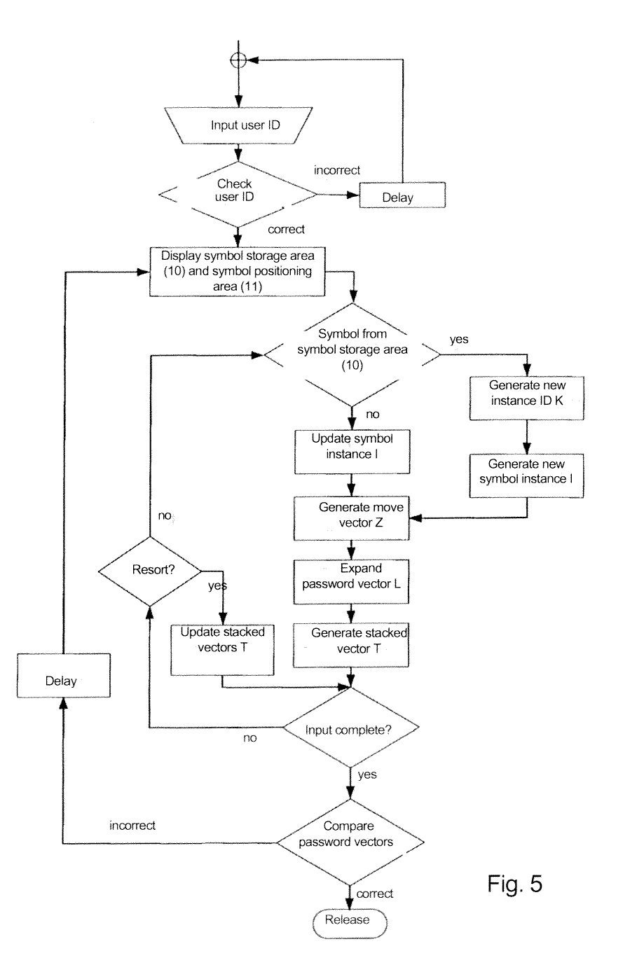

FIG. 5 shows a flow chart for depiction of the steps and processes for input of a graphical password according to a second exemplary embodiment;

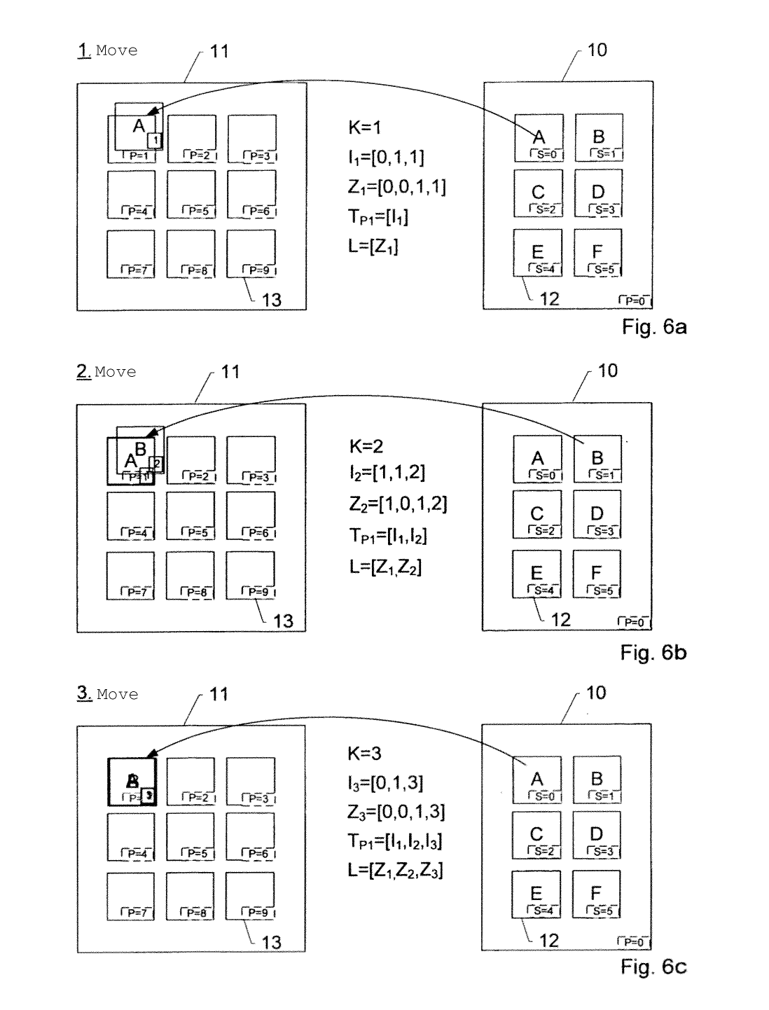

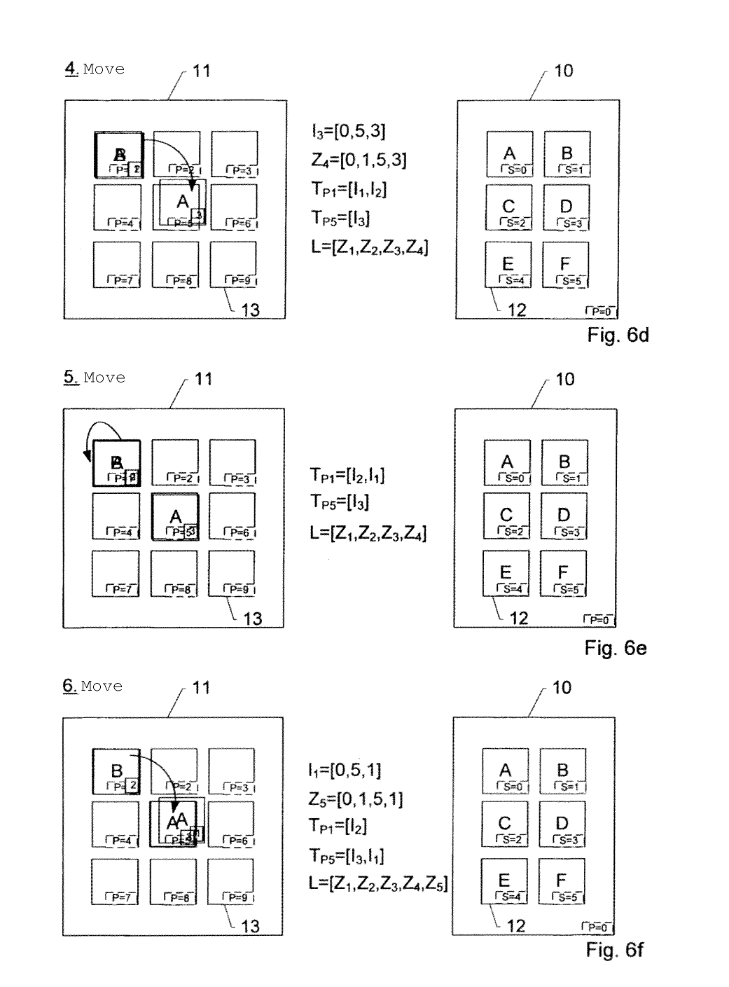

FIGS. 6a-6f show an example of a move with a plurality of moves for input of a graphical password according to a second exemplary embodiment;

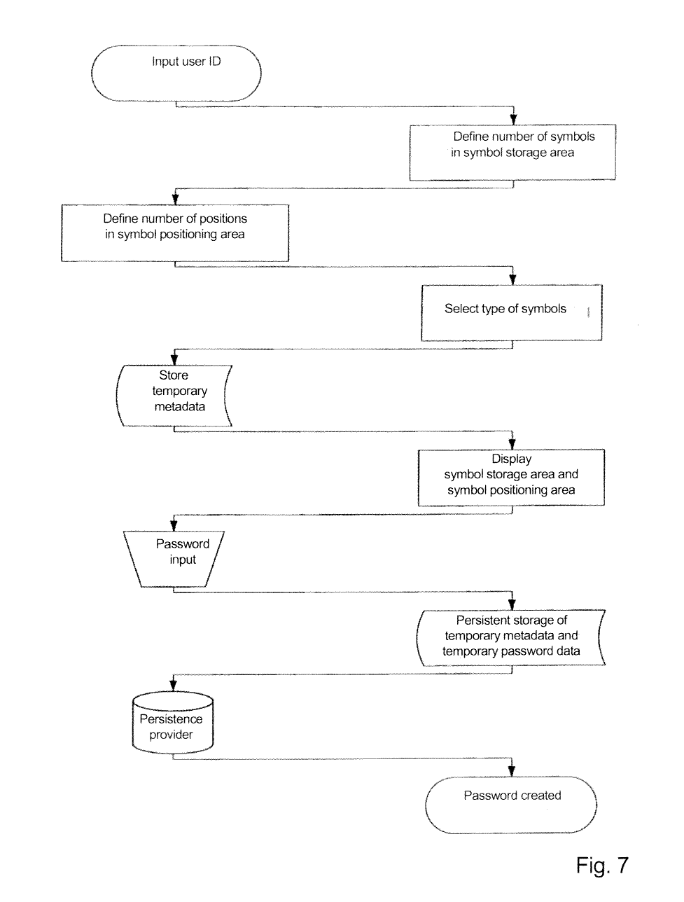

FIG. 7 shows a flow chart for the initial generation of a graphical password;

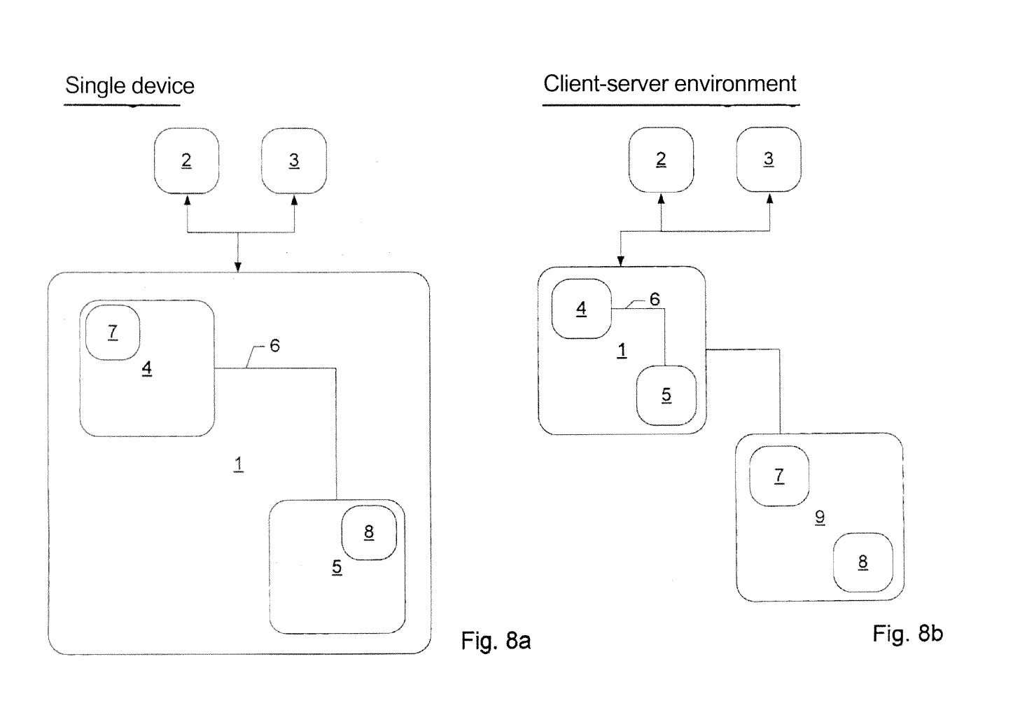

FIG. 8a shows the implementation of the method according to the invention on a single device;

FIG. 8b shows the implementation of the method according to the invention on a client-server environment.

FIG. 1 shows a schematic block diagram of a system in which the method according to the invention for authenticating a user can be implemented.

The system comprises for example a computing unit 1, a graphical user interfacing unit 2 and an input device 3. In particular the system can consist of a data processing and/or communication device, whose graphical user interfacing unit 2 and input device or input module 3 are connected by means of interfaces or a network with the additional computing unit.

The invention can therefore be used on all software-operated devices on which a user can interact with a computing unit 1 by means of an input device 3 and a graphical user interfacing unit 2, i.e. not only on mobile phones, personal digital assistants (PDAs), desktop or laptop computers, but also for example on input terminals of machines, for securing access to buildings or single rooms and also in client-server environments. Common to all of these environments, however, is the requirement for authenticating a user vis-a-vis the computing unit 1 to receive access to a protected resource. This protected resource can be the computing unit 1 itself, for example, or the device containing the computing unit 1, a protected file, a file area or also a building or a machine.

The computing unit 1 comprises a processor unit 4 and a memory unit 5, which are connected by a bus 6 for the bidirectional transmission of data. Control of the computing unit 1 by a user is achieved by means of the input device 3, which can be a keyboard, a mouse or a touch-sensitive display, for example. The graphical user interfacing unit 2 can in particular be a monitor or a display for the graphical display of information relevant for the control of the computing unit 1. In the event of a touch-sensitive display, also known as a touchscreen, in which the computing unit 1 is controlled by touching areas of the monitor, the graphical user interfacing unit 2 and the input device 3 are combined in one unit.

In the manner already known, programs stored for example in the memory unit 5 are processed in the processor unit 4 of the computing unit 1. As a result of this program processing, additional data can be generated, which for example are stored in the memory unit 5 or displayed on the graphical user interfacing unit 2. Authenticating a user on the computing unit 1 based on the method according to the invention is described in the following.

Authenticating a user vis-a-vis the computing unit 1 is achieved by a so-called “picture password” method, in which the information is authenticated by moving graphical symbols 12 on a user interface displayed on the graphical user interfacing unit 2 by input from a user on the input device 3. In the exemplary embodiment shown in FIG. 2 the user interface comprises a plurality of graphical symbols 12, which are arranged in a symbol storage area 10. The stored symbols are unlimited, i.e. the graphical symbols 12 can be used any number of times for creating a graphical password. In addition, the graphical user interface comprises a symbol positioning area 11, on which a plurality of positions 13 are arranged for placing graphical symbols 12. A symbol ID 5 is provided for differentiating the graphically different symbols 12. The single positions 13 of the symbol positioning area 11 and the symbol storage area 10 are associated with a unique position ID P, respectively.

The authenticating information is generated by moving graphical symbols 12 between the symbol storage area 10 and the symbol positioning area 11 and/or from the symbol positioning area 11 into the symbol storage area 10 and/or within the symbol positioning area 11. These single movement are referred to in the following as moves, the move between the symbol storage area 10 and the symbol positioning area 11 being designated 30, the move within the symbol positioning area 11 being designated 31 and the move from the symbol positioning area 11 into the symbol storage area 10 being designated 32.

During the execution of a move 30, 31, 32 a respective move vector Z is generated, which uniquely codes the executed move. The move vectors Z generated due to a plurality of moves 30, 31, 32 are then stored temporarily in the memory unit 5 in password vector L, namely taking into account the sequence. At the end of the password entry, which is defined by the user for example by means of a button on the input device 3 or by clicking a confirmation field 20 on the graphical user interface, the sequence of the move vectors Z contained in the password vector L and the values contained therein are evaluated for authenticating a user. This is done by comparing an originally created password vector, for example during set-up of a protected resource, with the temporarily stored password vector L. In the event that they are identical the user is granted access to the protected resource, for example a password protected file.

As shown in FIG. 2, the graphical symbols 12 of the symbol storage area 10 and the positions 13 of the symbol positioning area 11, on which symbol instances I generated by moves 30 can be placed, are arranged in the form of a matrix. When moving a symbol 12 from the symbol storage area 10 into the symbol positioning area 11 a symbol instance I is generated, and the symbol instances I are respectively associated with a symbol ID 5, by which the graphically differing symbols 12 can be differentiated, and a position ID P for identifying the current position of the symbol instance I. A symbol instance I generated by a move 30 between the symbol storage area 10 and the symbol positioning area 11 can for example be moved within the symbol positioning area 11 by a further move 31 or deleted by moving it from the symbol positioning area 11 back into the symbol storage area 10. This only changes the position ID P of the moved symbol instance I, namely the symbol instance I is always associated with the current position ID P on which the symbol instance I is currently placed.

In a preferred exemplary embodiment the moves 30, 31, 32 can be uniquely coded by means of move vectors Z only with the aid of the position ID P and the symbol ID 5, the move vectors Z comprising as values the symbol ID S and two position IDs P, namely one source position ID Q and one target position ID ZP. The source position ID Q is then the position ID P of the start position from which a symbol 12 is moved, and the target position ID ZP is the position ID P of the position to which the respective symbol 12 is moved.

Preferably it is possible to arrange a plurality of symbol instances I on one position 13 of the symbol positioning area 11, namely in a stack, each stack functioning according to the LIFO principle (last in, first out). This means that in the event that a plurality of symbol instances I are arranged at one position 13 of the symbol positioning area 11, at first only the topmost symbol 13 last placed on the stack can be moved. The symbol instances I underneath are covered by a symbol instance I placed on top. It is possible, however, to rearrange the symbol instances I within a stack, for example by clicking the topmost symbol instance I, in which case as a result of rearranging, the topmost symbol instance I becomes the bottommost and the symbol instance I previously beneath the topmost symbol instance can be moved.

Each move 30, 31, 32 results in a move vector Z, and a plurality of moves 30, 31, 32 executed consecutively with the corresponding move vectors Z constitute the password vector L. As opposed to the moves 30, 31, 32, simple rearranging of a stack is not evaluated as password information and therefore does not result in a move vector Z.

In the following, the steps of the authenticating method are described in more detail based on FIG. 3. A prerequisite for the method is that a user account with a user ID exists for the respective user and that this user has already created a graphical password, which is stored for example in the memory unit 5 and protected by security mechanisms. At the beginning of the method the respective user is prompted to enter his user ID. This user ID consists in the known manner preferably of a plurality of characters that uniquely identify the user. After confirming the input, for example by clicking a confirmation field on the graphical user interfacing unit 2 by means of the input device 3 the user ID is checked by the computing unit 1. In the event of incorrect input the user is prompted after a delay to enter the user ID again. In the event of a correct input of a user ID the symbol storage area 10 and the symbol positioning area 11 and a confirmation field 20 are displayed on the user interface (FIG. 2).

Due to the fact that the symbol positioning area 11 contains no symbol instances I at the start of the password input, the first move must necessarily be a move 30 from the symbol storage area 10 into the symbol positioning area 11. It is also possible, however, that symbol instances I are already arranged at positions 13 of the symbol positioning area 11 at the start of the password input. A move 30 generates a new symbol instance 1, the symbol instance 1 being a vector that contains as values the symbol ID S of the moved symbol 12 and a position ID P that characterizes the position of the symbol 12 after the move. To identify the move 30 a move vector Z is also generated that contains as values the symbol ID S of the moved symbol instance I, the source position ID Q and the target position ID ZP. After the move vector Z is generated it is temporarily stored in the password vector L. This serves to store the moves 30, 31, 32 executed consecutively and defined by move vectors Z. Afterwards, stacked vectors T are generated or updated, each position 13 of the symbol positioning area 11 being associated with one such stacked vector T. The stacked vectors T receive as values symbol instances I, the symbol instances I received in a stacked vector T being stacked at one position 13 of the symbol positioning area, namely the first symbol instance I in the stacked vector T designating the bottommost symbol instance I in the stack.

Then a check is conducted to determine whether the input of the graphical password was completed, for example by actuating the confirmation field 20. If the confirmation field 20 is not actuated, the further move 30, 31, 32 must be executed by the user, in which case it is first differentiated whether the next move 30, 31, 32 is a rearranging of a stack of symbol instances arranged at a position 13 (move 31). In the event that a rearranging of a stack has taken place, only the stacked vectors T of the respective position 13 are updated. Since the rearranging of the stacked vectors T does not result in generation of a move vector Z, such rearranging is not relevant for the coding of the graphical password.

In the event that no rearranging takes place, during the move a differentiation is then made accordingly, whether this move 30 results in movement of a symbol 12 from the symbol storage area 10 into the symbol positioning area 11 or whether the move is a move 31 or move 32, which moves a symbol instance I within the symbol positioning area 11 or deletes a symbol instance I by moving it into the symbol storage area 10. In the event that a symbol 12 from the symbol storage area 10 is used, the ensuing sequence of steps is the same as described above for the first move of creating the password.

Otherwise no new symbol instance I is generated; instead, only an already existing symbol instance I is updated. This is followed by the generation of the move Z, the expansion of the password vector L and the generation or updating of the stacked vectors T. After the user has executed an arbitrary sequence of moves 30, 31, 32 and rearranging of symbol instances I arranged on stacks and the creation of the password has been completed by actuating the confirmation field 20, a comparison of the password vector L with password information stored in the memory unit 5 is executed. The exact processes for the comparison of the password vector L with stored password information are described in more detail in the following. In the event that the password comparison is positive, the protected resource is released. In the event of an incorrect graphical password input, the user is prompted after a delay to enter the graphical password again. The purpose of this delay is to make it much more difficult to automatically enter a password, for example by “brute force methods”.

In the following, a succession of moves for creating a graphical password is described based on FIGS. 4a through 4f. The symbol storage area 10 in the example shown here comprises six different graphical symbols A, B, C, D, E, F, each symbol being associated with a unique symbol ID S (S=0, 1, . . . , 5). The symbol positioning area 11 comprises nine positions 13 arranged in the form of a matrix, each position 13 being uniquely identified by a position ID P (P=1, 2, . . . , 9). In addition, the symbol storage area 10 is associated with the position ID P=0, so that as a result of a symbol instance I moved out of the symbol storage area 10 or into the symbol storage area 10 a move vector Z is generated, with which the position ID P=0 can be associated as a source position ID Q or as a target position ID ZP, respectively.

In the first move (FIG. 4a) a symbol instance I₁ with the symbol ID S=0 and the position ID P=1 is generated, the symbol ID S=0 designating the symbol A and the position ID P=1 designating the target position of the symbol. To code the move a move vector Z is generated that contains as values the symbol ID S, the source position ID Q and the target position ID P. For this first move the move vector Z₁ contains the values S=0, Q=0, Z=1 (Z₁=[0, 0, 1]). As a result of positioning the symbol instance I₁ at the position with the position ID P=1 this position is associated with a stacked vector T_{P1}, which contains as a value the symbol instance I₁. At the end of the move the password vector L is generated and is associated with the value of the move vector Z₁(L=[Z₁]).

In the second move (FIG. 4b) a symbol is again placed at the position with the position ID P=1. of the positioning area 11, namely the graphical symbol B, which is associated with the symbol ID S=1.

Due to this move a symbol instance I₂ with the values S=1 and P=1 is initially generated (I₂=[1, 1]). The move itself is designated by the move vector Z₂, which contains the values S=1, Q=0 and P=1 (Z₂=[1, 0, 1]). The stacked vector T_{P1} associated with the position P=1 is expanded to include the symbol instance I₂, so that the stacked vector T_{P1} contains the symbol instances I₁ and I₂, namely in the sequences in which the symbol instances I₁, I₂ were placed at the position P=1 (T_{P1}=[I₁, I₂]). In addition, the password vector L is expanded to include the move vector Z₂ (L=[Z₁, Z₂]).

In the third move (FIG. 4c) a graphical symbol A is with the symbol IDS=0 is again placed at the position with the position ID P=1. It therefore becomes clear that graphically identical symbols can be used any number of times, such as the symbol A used twice in this example. Due to this move a third symbol instance I₃ with the values S=0 and P=1 is generated (I₃=[0, 1]). The move vector Z₃ generated for this purpose has the values S=0, Q=0, P=1 (Z₃=[0, 0, 1]). The stacked vector T_{P1} associated with the position P=1 is expanded to include the symbol instance I₃, so that the stacked vector T_{P1} then consists of the three values of the symbol instances I₁, I₂, I₃. At the end of the third move the password vector L is expanded to include the move vector Z₃ (L=[Z₁, Z₂, Z₃]).

In the fourth move (FIG. 4d) the symbol instance I₃ is moved from the position with the position ID P=1 to the position with the position ID P=5. It is obvious that after generating stacks of symbol instances I, the last symbol instance I placed on the stack can be used, respectively. The use of the symbol instances underneath (I₂, I₁) is possible by rearranging, for example by clicking the respectively topmost symbol instance I (see fifth move, FIG. 4e). As a result of moving the symbol instance I₃ within the symbol positioning area 11, the symbol instance I₃ is updated, namely in particular its position ID P. It is associated with the value of the position ID of the position to which the symbol instance I₃ was moved, i.e. the value P=5 (I₃=[0, 5]). Afterwards, the move vector Z₄ is generated, which is associated with the value Q=1 as the source position ID and the value ZP=5 as the target position ID (Z₄=[0, 1, 5]). Then the stacked vectors T_{P1}, T_{P5} have to be updated and generated, respectively. The symbol instance I₃ is removed from the stacked vector T_{P1} (T_{P1}=[I₁, I₂]) and the symbol instance I₃ is added to the newly generated stacked vector T_{P5} (T_{P5}=[I₃]). At the end of the move the password vector L is expanded to include the move vector Z₄ (L=[Z₁, Z₂, Z₃, Z₄]).

In FIG. 4e the stack at the position with the position ID P=1 with the symbol instances I₁, I₂ is rearranged, for example as a result of clicking the position. This rearranging itself does not generate a new move vector Z, but only affects the stacked vector T_{P1}. The rearranging causes the symbol instances I₁, I₂ to be moved within the stacked vector T_{P1} in the manner that the last symbol instance in the stacked vector T_{P1} is set to the first position, so that all other symbol instances within the vector are moved back one position. For the stack of symbol instances I visible on the graphical user interface this means that the topmost symbol instance (here the symbol instance I₂) takes the bottommost position in the stack and the originally first generated symbol instance I₁ is now at the top of the stack. Otherwise, there are no changes to the temporarily stored data, in particular not to the password vector L.

In the sixth move (FIG. 4f) the symbol instance I_{I} positioned at the top of the stack due to rearranging in the fifth move is now moved from the position with the position ID P=1 to the position with the position ID P=5. In this connection the symbol instance I, is updated, namely the value designating the position of the respective symbol instance I is set to 5 (I₁=[0, 5]). Afterwards, a move vector Z₅ is generated, which receives the value S=0 as the symbol ID S, the value Q=1 as the source position ID Q and the value ZP=5 as the target position ID ZP (Z₅=[0, 1, 5]). Then the stacked vectors T_{P1} and T_{P5} are updated. In this connection the instance I₁ is deleted from the stacked vector T_{P1} and added to the stacked vector T_{P5} (T_{P1}=[I₂], T_{P5}=[I₃, I₁]). Lastly, the move vector Z₅ is added to the password vector L, so that at the end of the six moves there is a password vector L with five move vectors Z₁, Z₂, . . . , Z₅.

The password vector L generated by the moves described above uniquely characterizes the moves made by the user on the graphical user interface, the values of the single move vectors Z and the sequence of the move vectors Z arranged in the password vector L both being decisive for the graphical password for authenticating the user on the computing unit 1. In this connection it is possible to use graphically identical symbols 12 (in the example shown above, the double use of the symbol “A” with the symbol ID S=0) more than once. For the case that graphically identical symbols 12 are arranged at one position 13 of the symbol positioning area 11, it is irrelevant which symbol instance I of these graphically identical symbols 12 is used for a move to another position 13 in the symbol positioning area 11 or in the symbol storage area 10. One reason for this is that rearranging a stack does not generate move information in the form of a move vector Z and the rearranging therefore does not find its way into the password vector L. Also, it can be seen in FIGS. 4d and 4f that moving the two symbols “A” from the position with the position ID P=1 to the position with the position ID P=5 generates two identical move vectors Z₄ and Z₅, i.e. in case of graphically identical symbols 12 the move vectors are independent of the symbol instance I.

In the following, a second exemplary embodiment is described, wherein during the generation of a symbol instance I the latter is associated with an instance ID K and this instance ID K is displayed to the user in a field associated with the respective symbol instance I. This instance ID K makes it possible to differentiate graphically identical symbol instances I from each other. Due to the fact that this instance ID K also finds its way into the respective move vector Z, it is relevant for the user authentication which symbol instance I is used by graphically identical symbols 12. First, based on FIG. 5, the generation of a graphical password is described, using the instance ID K as opposed to the password generation shown in FIG. 3.

As shown by a comparison of the flow chart in FIG. 5 for the authenticating method according to the second exemplary embodiment with the flow chart in FIG. 3 for the first exemplary embodiment, the processes for generating the graphical passwords are the same and differ only in the generation of a new symbol instance I, namely that an instance ID K is generated prior to generation of the new symbol instance I. The instance ID K is numbered consecutively, for example the first symbol instance being associated with the instance ID K=1, and the newly generated symbol instances I₂, I₃, etc. being associated with the instance IDs K=2, K=3, etc. Consequently, each graphical symbol positioned in the symbol positioning area 11 comprises a field that is graphically associated with the symbol instance I, located in particular in an area in which the instance ID K associated with the symbol instance I is displayed to the user, for example in a corner of the graphical symbol. This allows a user to differentiate a plurality of graphically identical symbols, i.e. symbols with the same symbol ID S, located at one position 13 of the symbol positioning area 11. As opposed to the first exemplary embodiment it is now relevant for creating the password, which symbol instance I with the same symbol ID S is used from a stack of symbols, since the instance ID K is part of the move vector Z and therefore also finds its way into the password vector L.

In the following, based on an example move, creating a graphical password according to the second exemplary embodiment (FIGS. 6a through 6f) is described in more detail. The single moves of the example are identical to the example move of the first embodiment shown in FIGS. 4a through 4f. For this reason, only the differences in comparison with the first example of the first embodiment are discussed in the following. Otherwise, the explanation provided there applies.

In the first move (FIG. 6a) a symbol instance I with the symbol ID S=0, which consists for example of a symbol 12 with the letter “A”, is moved to the position 13 of the symbol positioning area 11 with the position ID P=1. This generates a symbol instance in the form of a vector, which contains as values the symbol ID S=0, the position ID P=1 and the instance ID K=1. This instance ID K=1 is also found on the symbol that was placed, for example in a field that is associated with the moved symbol. This instance ID K=1 remains permanently associated with the symbol instance I₁, regardless of its being moved or rearranged. The move vector Z₁ generated as a result of this move contains, in addition to the symbol ID S=0, the source position ID Q=0 and the target position ID ZP=1, also the instance ID K=1 (Z₁=[0, 0, 1, 1]). It should be noted that the move vector Z does not necessarily have to contain the source position ID Q, since the move coding is also unambiguous if the symbol positioning area 11 is empty at the start of creating the password, i.e. no symbol instances I already exist during the generation of the symbol positioning area 11.

In the second move (FIG. 6b) a symbol instance I₂ with the symbol ID S=1, i.e. a symbol instance I with the graphical symbol “B” is generated and likewise placed at the position with the position ID P=1. The symbol instance I₂ is associated with the instance ID K=2, so that the symbol instance I₂ consists of a vector with the values S=1, P=1, K=2 (I₂=[1, 1, 2]). The move vector Z₂ associated with this move is Z₂=[1, 0, 1, 2].

With the third move (FIG. 6c) a third symbol instance I₃ is generated, which is associated with the instance ID K=3. The symbol is again a symbol with the letter “A” with the symbol ID S=0, which again is placed at the position with the position ID P=1 of the symbol positioning area 11. The symbol instance I₃ thus generated is I₃=[0, 1, 3] and the move vector Z₃ associated with this move is Z₃=[0, 0, 1, 3]. After the third move, therefore, the stacked vector T_{P1} comprises the three symbol instances I₁, I₂ and I₃. The temporarily stored password vector contains the move vectors Z₁, Z₂, Z₃ generated by the moves thus far.

In the fourth move (FIG. 6d) the last generated symbol instance I₃ is moved from the position with the position ID P=1 to the position with the position ID P=5. As a result of this move the value of the position ID P contained in the symbol instance I₃ and characterizing the current position of the symbol instance I₃ is set to 5 and a move vector Z₄ is generated, which is associated with the value S=0 as the symbol ID, the value Q=1 as the source position ID, the value ZP=5 as the target position ID and the value K=3 as the instance ID. In addition, a new stacked vector T_{P5} is generated, which receives the symbol instance I₃. This symbol instance I₃ is removed from the stacked vector T_{P1}.

Corresponding to the first example move, in the fifth move (FIG. 6e) a rearranging of the stack of symbol instances at the position with the position ID P=1 is executed, which changes the sequence of the symbol instances I₁, I₂ contained in the stacked vector T_{P1}. This means that the symbol instance I₁ rises to the top of the stack and can therefore be moved.

In the sixth move (FIG. 6f), the symbol instance I₁ now at the top of the stack after rearranging is moved from the position with the position ID P=1 to the position with the position ID P=5. Accordingly, the position ID of the symbol instance I₁ is changed to the value P=5. This move is characterized by the move vector Z₅, which contains as values the symbol ID S=0, the source position ID Q=1, the target position ID ZP=5 and the instance ID K=1 (Z₅=0, 1, 5, 1). By comparing the sixth move with the fourth move it becomes clear that the coding of movements of graphically identical symbols between the position with the position ID P=1 and the position with the position ID P=5 based on the instance ID K generate different move vectors Z₄, Z₅ and that during the creation of the graphical password it is very important which symbol instance I from a plurality of graphically identical symbols stacked at one position is used for moving. Such a difference does not exist in the first exemplary embodiment. Therefore, it is necessary for a user, when creating a graphical password according to the second exemplary embodiment, to remember not only the symbol, but also the instance ID K.

To protect a computing unit 1, particular areas of a computing unit 1. or other resources by means of a graphical password, it is necessary first to generate a graphical password and assign it to this protected area. The password is generated according to the flow chart in FIG. 7. For this purpose it is first necessary preferably for the user to enter a user ID, which can consist in particular of an arbitrary character string. This is necessary for protected resources to be accessible by more than one user. If the protected resource is accessed by only one user the entry of the user ID can be omitted. Entering the user ID associates the user ID with a user account. In a subsequent step the number of symbols 12 in the symbol storage area 10 is defined. This number defines how many graphically different symbols 12 are available for generating the graphical password. Afterwards, the number of positions 13 in the symbol positioning area 11 on which the symbols 12 of the symbol storage area 10 can be placed is defined. In the next step it is necessary to choose the type of symbols 12 in the symbol storage area 10. In this step different symbol pallets can be used, for example symbol pallets with animals, objects, colors or color gradients, chess figures, user-defined images, abstract graphics or high-contrast pallets for visually impaired persons.

After selecting or defining these parameters they are stored as temporary metadata in a memory unit 5. Afterwards, based on the stored parameters, a symbol storage area 10 with symbols 12 and a symbol positioning area 11 with positions 13 is displayed on the graphical user interfacing unit 2, for example as shown in FIG. 2. Now the graphical password is entered by moving symbols 12 into the symbol positioning area 11, by moving symbols within the symbol positioning area 11 or by moving the symbols from the symbol positioning area 11 back into the symbol storage area 10. To prevent errors, the user preferably is prompted again to repeat the sequence of moves entered, to prevent a protected resource from becoming no longer usable for the user due to erroneous input. If the two graphical passwords entered are identical, the metadata initially stored temporarily and the temporarily stored password data are stored persistently by the persistence provider 8. The process of creating the graphical password is thus complete.

FIGS. 8a and 8b show schematic representations of hardware environments on which the authenticating method according to the invention can be used. FIG. 8a shows the application of the authenticating method on a single device. The password sequence entered by means of the input device 3 and displayed on the graphical user interfacing unit 2 is first stored temporarily in the memory unit 5. After completion of the input the temporarily stored password vector and the password originally entered by the user and provided by the persistence provider 8, is passed to the verifier 7, which compares the two graphical passwords, i.e. checks whether the currently entered password vector L is identical to the originally stored password vector L. Preferably the currently entered and the originally stored password vector L are compared with each other in encrypted form, for example converted into a unique character string by a hash algorithm. In the event that the verifier 7 determines that the two passwords are identical, the protected resources are released. Therefore, the verifier 7 itself does not need to know the originally entered graphical password; instead, it only compares the currently entered graphical password with the originally entered password. This significantly increases the security of the authenticating method.

FIG. 8b shows a client-server environment, in which the client consists of the computing unit 1 with the graphical user interfacing unit 2 and the input device 3 and is connected to a server 9 by means of a data connection, for example in the form of a network connection or a wide area network. As opposed to FIG. 8a the computing unit 1 does not comprise a verifier 7 and a persistence provider 8; instead, these units are allocated to the server 9. The password entered at the input device 3 is temporarily stored in the computing unit 1, in the memory unit 5. After the password has been entered the temporarily stored password vector L is transmitted to the verifier 7 by means of the data connection. For secure transmission via the data connection the password vector L can be encrypted, for example with a hash function, for example converted to a unique character string with a combination of MD5 and SHA1 algorithms. Said conversion is executed within the server 9 with the originally stored password vector L, the converted, unique character string then being provided for comparison in the verifier 7. If the currently entered password vector L is identical to the originally entered password vector L, this results in identical character strings, so that the user is enabled access to the protected resource. It goes without saying that a plurality of computing units 1 can be connected to the server 9, for example with different graphical user interfacing units 2 and input devices 3. This can be the case especially in a computer network consisting of a plurality of clients 1 and a central server 9.

The invention was described above based on an exemplary embodiment. It goes without saying that numerous modifications and variations of the invention are possible without abandoning the underlying inventive idea.

### REFERENCE LIST

1 computing unit
2 graphical user interfacing unit
3 input device
4 processor unit
5 memory unit
6 bus
7 verifier
8 persistence provider
9 server
10 symbol storage area
11 symbol positioning area
12 symbol
13 position
20 confirmation field
30 move
31 move
32 move
I symbol instance
K instance ID
L password vector
P position ID
Q source position ID
s symbol ID
T stacked vector
Z move vector
ZP target position ID

1. Method for authenticating a user on at least one computing unit (1), in particular a data processing and/or communication device comprising a graphical user interfacing unit (2) having a graphical user interface and at least one input device (3), wherein the at least one graphical user interface comprises at least one symbol storage area (10) having a plurality of graphical symbols (12) and at least one symbol positioning area (11) having a plurality of defined positions (13), wherein
the symbols (2) can be used more than once,
each symbol (12) of the symbol storage area (10) is associated with at least one symbol ID (S),
each position (13) of the symbol positioning area (11) and the symbol storage area (10) is associated with at least one position ID (P),
moving one symbol (12) respectively from the symbol storage area (10) into the symbol positioning area (11) generates one symbol instance (1),
moving one symbol (12) respectively from the symbol storage area (10) into the symbol positioning area (11) and/or from the symbol positioning area (11) into the symbol storage area (10) and/or within the symbol positioning area (11) generates at least one move vector (Z), which comprises at least the symbol ID (S) of the moved symbol (12), a source position ID (Q) defining the position of the symbol (12) before the move and a target position ID (ZP) defining the position of the symbol (12) after the move, and
the sequence of at least two move vectors (Z) and their respective symbol ID (S), source position ID (Q) and target position ID (ZP) are evaluated for authenticating a user on at least one computing unit (1).

2. Method for authenticating a user on at least one computing unit (1), in particular a data processing and/or communication device comprising a graphical user interfacing unit (2) having a graphical user interface and at least one input device (3), wherein the at least one graphical user interface comprises at least one symbol storage area (10) having a plurality of graphical symbols (12) and at least one symbol positioning area (11) having a plurality of defined positions (13), wherein
the symbols (12) can be used more than once.
each symbol (12) of the symbol storage area (10) is associated with at least one symbol ID (S),
each position (13) of the symbol positioning area (11) and the symbol storage area (10) is associated with at least one position ID (P),
moving one symbol (12) respectively from the symbol storage area (10) into the symbol positioning area (11) generates one symbol instance (I),
graphically moving one symbol (12) respectively from the symbol storage area (10) into the symbol positioning area (11) and/or from the symbol positioning area (11) into the symbol storage area (10) and/or within the symbol positioning area (11) generates at least one move vector (Z), which comprises at least the symbol ID (S) of the moved symbol (12), a target position ID (ZP) defining the position of the symbol (12) after the move and an instance ID (K) permanently associated with the respectively used symbol (12), and
the sequence of at least two move vectors (Z) and their respective symbol ID (S), target position ID (ZP) and instance ID (K) are evaluated for authenticating a user on at least one computing unit (1).

3. Method according to claim 2, characterized in that graphically identical symbol instances (I) are differentiated by the instance ID (K) associated with a symbol instance (I).

4. Method according to claim 2, characterized in that the instance ID (K) is displayed to the user as being permanently associated with the respective symbol instance (I).

5. Method according to claim 2, characterized in that the move vector (Z) additionally contains the source position ID (Q) defining the position of the graphical symbol (12) before the move and said source position ID is used for authenticating a user on at least one data processing and/or communication device.

6. Method according to claim 2, characterized in that a plurality of graphically identical and/or different symbol instances (I) are arranged at one position (13) of the symbol positioning area (11).

7. Method according to claim 6, characterized in that a plurality of graphically identical and/or different symbol instances (I) arranged at one position (13) of the symbol positioning area (11) are rearranged by a user input.

8. Method according to claim 7, characterized in that no move vector is generated during rearranging.

9. Method according to claim 8, characterized in that the positions (13) of the symbol positioning area (11) are displayed in the form of a matrix or table on the graphical user interface.

10. Method according to claim 9, characterized in that a plurality of move vectors (Z) are temporarily stored in one password vector (L).

11. Method according to claim 10, characterized in that the password vector (L) is converted to a unique character string by means of a hash function, in particular a combination of MD5 and SHA algorithms.

12. Method according to claim 11, characterized in that the password vector (L) or the character string generated by means of a hash function is passed to a verifier (7).

13. Method according to claim 10, characterized in that in the verifier (7) the password vector (L) or the character string generated by means of the hash function is compared with authenticating information stored in the memory unit (5).

14. Method according to claim 2, characterized in that the password defined by a user is stored by a persistence provider.

15. Method according to claim 2, characterized in that in addition to the symbols (12) relevant for entering the password, neutral symbols are provided in the symbol storage area (10) that are not evaluated as password information.

16. Method according to claim 15, characterized in that the symbols are rotated by discrete angle values, for example by 90°, 180° or 270°.

17. Method according to claim 16, characterized in that angle information associated with the rotated symbol instance (I) is stored in the move vector (Z).

18. Method according to claim 2, characterized in that the size of the symbol storage area (10) and/or the number of positions (13) in the symbol positioning area (11) and/or the symbol pallet used are configured by the authenticated user.

19. Device with a graphical user interfacing unit (2) and an input device (3), characterized by the use of a method for authenticating a user according to claim 2.
